(19) United States
(12) Patent Application Publication
(10) Pub. No.: US 2009/0190106 A1
(43) Pub. Date: Jul. 30, 2009

(54) IMMERSION LITHOGRAPHY APPARATUS

(75) Inventors: Harry SEWELL, Ridgefield, CT (US); Louis John Markoya, Sandy Hook, CT (US)

Correspondence Address: PILLSBURY WINTHROP SHAW PITTMAN, LLP, P.O. BOX 10500, MCLEAN, VA, 22102, US

(73) Assignee: ASML HOLDING NV, Veldhoven (NL)

(21) Appl. No.: 12/358,931

(22) Filed: Jan. 23, 2009

Related U.S. Application Data
(60) Provisional application No. 61/024,323, filed on Jan. 29, 2008.

(51) Int. Cl. G03B 27/52

(52) U.S. Cl. 355/30

(57) ABSTRACT

An immersion lithographic apparatus is disclosed having a projection system, a liquid supply system, and a recycling system. The projection system is configured to project a patterned radiation beam onto a target portion of a substrate, wherein a substrate table is configured to support the substrate. The liquid supply system is configured to provide an immersion liquid to a space between the projection system and the substrate or the substrate table. The recycling system is configured to collect the immersion liquid from the liquid supply system and to supply the immersion liquid to the liquid supply system. The recycling system includes a fiber configured to remove organic contaminants from the immersion liquid.

This application claims priority and benefit under 35 U.S.C. §119(e) to U.S. Provisional Patent Application No. 61/024,323, entitled “An Immersion Lithography Apparatus”, filed on Jan. 29, 2008. The content of that application is incorporated herein in its entirety by reference.

### FIELD

The present invention relates to an immersion lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging the pattern using an ultraviolet (UV) radiation beam onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g., water or a hydrocarbon liquid, so as to fill a space between the final element of the projection system and the substrate. The liquid may be distilled water, although another liquid could be used. The description herein references a liquid. However, another fluid may be suitable, particularly a wetting fluid, an incompressible fluid, and/or a fluid with a higher refractive index than air, desirably a higher refractive index than water. The point of this is to enable imaging of smaller features since the exposure radiation will have a shorter wavelength in the liquid (the effect of the liquid may also be regarded as increasing the effective numerical aperture (NA) of the system and also increasing the depth of focus). Organic fluids are one of the liquids being considered for use in immersion lithography instead of water. These organic fluids have a higher refractive index than water and typically comprise a hydrocarbon, such as decahydronaphthalene (also known as Decalin), a fluorhydrocarbon or a cubane dispersed in an organic solvent. Other immersion liquids have been proposed, including water with solid particles (e.g., quartz) suspended therein.

A twin or dual stage immersion apparatus may be provided. In such an apparatus, two or more substrate tables are provided to respectively support a substrate. Leveling measurements are carried out with a substrate table at a first position, without immersion liquid, and exposure is carried out with a substrate table at a second position, where immersion liquid is present. Alternatively, there may be only one substrate table.

Submersing the substrate or substrate and substrate table in a bath of liquid means that there is a large body of liquid that must be accelerated during a scanning exposure. This requires additional or more powerful motors and the resulting turbulence in the liquid may lead to undesirable and unpredictable effects.

### SUMMARY

A problem encountered with an immersion lithographic apparatus is the occurrence of contaminating particles within the immersion system and on the surface of the substrate. The presence of a particle in the immersion system may cause a defect to occur during the exposure process when the particle is present between the projection system and the substrate being exposed. When using an organic fluid as an immersion fluid, the organic fluid may break down into contaminants when exposed to radiation from the UV radiation beam. The contaminants form sticky deposits on surfaces of the last element of the projection system and the substrate. Purification techniques can recondition and purify the immersion liquid to reduce the amount of contaminants and improve the optical transmission of the liquid. In one such purification technique, these contaminants are filtered out of the liquid by passing the liquid through a bed of SiO₂ particles. However, a problem associated with such beds is particulate generation. The grains in the bed rub against each other as the immersion fluid flows through the bed, thus causing the grains to shed particles. The particles are released into the fluid as it flows through the bed, contaminating the immersion fluid before it enters the immersion system. The particles cause particulate contamination and are sized as nano-particles. Although a filter can be used to trap most of the particles, such a filter can become easily clogged due to the large amount of generated particles. In such an instance, particles may be allowed to contaminate the immersion system and substrates after exposure.

Therefore, what is needed is an apparatus and a method to reduce the presence of contaminating particles in an immersion lithography system without generating additional particles.

In an embodiment, there is provided a lithographic apparatus comprising a projection system, a liquid supply system, and a recycling system. The projection system is configured to project a patterned radiation beam onto a target portion of a substrate, wherein a substrate table is configured to support the substrate. The liquid supply system is configured to provide a liquid to a space between the projection system and the substrate or the substrate table. The recycling system is configured to collect liquid from the liquid supply system and to supply the liquid to the liquid supply system. The recycling system includes a fiber to filter organic particles.

In an embodiment, there is provided a device manufacturing method comprising: projecting a patterned beam of radiation onto a substrate through a liquid provided in a space between a projection system and a substrate; removing liquid from the space and filtering the liquid using a particle filter comprising a fiber; and providing at least some of the filtered liquid to the space. In an embodiment, the method further comprises measuring a physical property of the liquid indicative of its quality. In an embodiment, the method further comprises adjusting the filtering of the liquid based on the measurement of the physical property of the liquid.

Further embodiments, features, and advantages of the various embodiment of the present invention, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 depicts a lithographic apparatus according to an embodiment of the invention.

FIGS. 2 and 3 depict an embodiment of a liquid supply system for use in a lithographic projection apparatus.

FIG. 4 depicts an embodiment of a liquid supply system for use in a lithographic projection apparatus.

FIG. 5 depicts an embodiment of a liquid supply system for use in a lithographic projection apparatus.

FIG. 6 depicts an embodiment of a recycling system for use in or with a lithographic projection apparatus.

FIG. 7 depicts an embodiment of a liquid treatment unit for use in or with a recycling system of a lithographic projection apparatus.

FIG. 8 depicts an embodiment of a recycling system for use in or with a lithographic projection apparatus.

One or more embodiments of the present invention will now be described with reference to the accompanying drawings. In the drawings, like reference numbers can indicate identical or functionally similar elements.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment cannot necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention can be implemented in hardware, firmware, software, or any combination thereof. Embodiments of the invention can also be implemented as instructions stored on a machine-readable medium, which can be read and executed by one or more processors. A machine-readable medium can include any mechanism to store or transmit information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

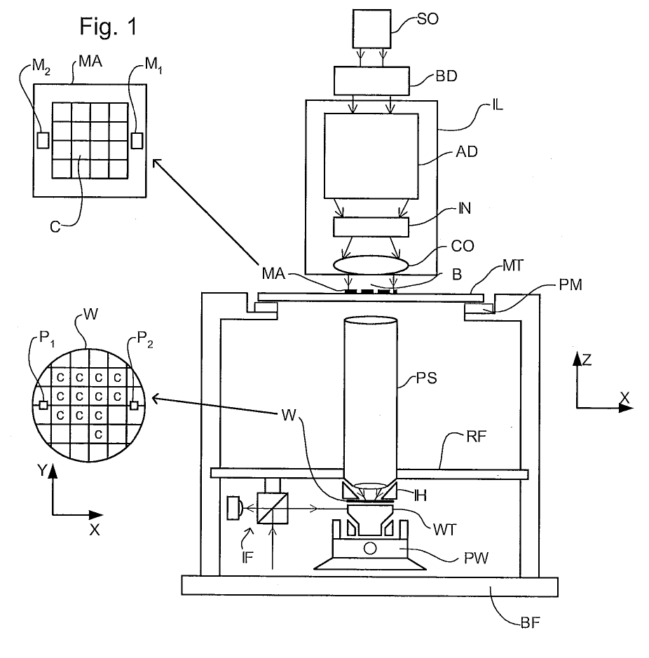

FIG. 1 schematically depicts an embodiment of lithographic apparatus suitable for use with an embodiment of the invention. The apparatus comprises an illumination system (illuminator) IL configured to condition a radiation beam B (e.g., UV radiation or DUV radiation); a support structure (e.g., a mask table) MT constructed to support a patterning device (e.g. a mask) MA and connected to a first positioner PM configured to accurately position the patterning device MA in accordance with certain parameters; a substrate table (e.g., a wafer table) WT constructed to hold a substrate (e.g., a resist-coated wafer) W and connected to a second positioner PW configured to accurately position the substrate W in accordance with certain parameters; and a projection system (e.g. a refractive projection lens system) PS configured to project a pattern imparted to the radiation beam B by patterning device MA onto a target portion C (e.g., comprising one or more dies) of the substrate W. In an embodiment, the projection system is supported by a reference frame RF, which in turn is supported by a base frame BF.

The illumination system may include various types of optical components, such as refractive, reflective, magnetic, electromagnetic, electrostatic or other types of optical components, or any combination thereof, for directing, shaping, or controlling radiation.

The support structure MT holds the patterning device. It holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as required. The support structure MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases, the source SO may be an integral part of the lithographic apparatus, for example when the source SO is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam B is projected onto a target portion C (i.e., a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion C.

3. In another mode, the support structure MT is kept essentially stationary holding a programmable patterning device, and the substrate table WT is moved or scanned while a pattern imparted to the radiation beam B is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

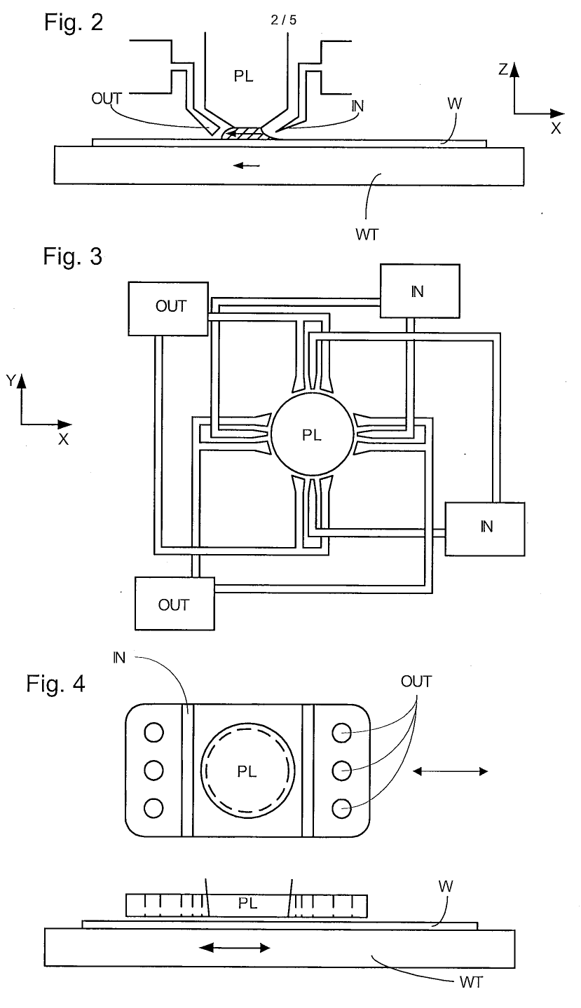

In an embodiment, an immersion lithography apparatus includes a liquid supply system that provides liquid on only a localized area of the substrate and in between the final element of the projection system and the substrate using a liquid confinement system (the substrate generally has a larger surface area than the final element of the projection system). Such an embodiment is depicted in FIGS. 2 and 3. In FIG. 2, a liquid is supplied by at least one inlet IN onto the substrate W, desirably along the direction of movement of the substrate W relative to the final element, and is removed by at least one outlet OUT after having passed under the projection system PL. Therefore, as the substrate W is scanned beneath the element in a −X direction, liquid is supplied at the +X side of the element and taken up at the −X side. A liquid is supplied via inlet IN and is taken up on the other side of the element by outlet OUT which is connected to a low pressure source.

In the embodiment of FIG. 2, the liquid is supplied along the direction of movement of the substrate W relative to the final element, although the present invention is not limited to such a configuration. In additional embodiments, various orientations and numbers of inlets and outlets positioned around the final element are possible without departing from the spirit or scope of the present invention. For example, FIG. 3 depicts an exemplary orientation of inlets and outlets in which four sets of an inlet IN with an outlet OUT on either side are provided in a regular pattern around the final element.

An immersion lithography apparatus with a localized liquid supply system is shown in FIG. 4. Liquid is supplied by two groove inlets IN on either side of the projection system PL and is removed by a plurality of discrete outlets OUT arranged radially outwardly of the inlets IN. The inlets IN and outlets OUT can be arranged in a plate with a hole in its center and through which the projection is project. Liquid is supplied by one groove inlet IN on one side of the projection system PL and removed by a plurality of discrete outlets OUT on the other side of the projection system PL. In the embodiment of FIG. 4, the groove inlet IN generates a flow of a thin film of liquid between the projection system PL and the projection system PL, which is removed by a plurality of discrete outlets OUT on the other side of the projection system PL, thus generating a flow of a thin film of liquid between the projection system PL and the substrate W. In various embodiments, the choice of a combination of inlet IN and outlets OUT can depend on the direction of movement of the substrate W (the other combination of inlet IN and outlets OUT being inactive).

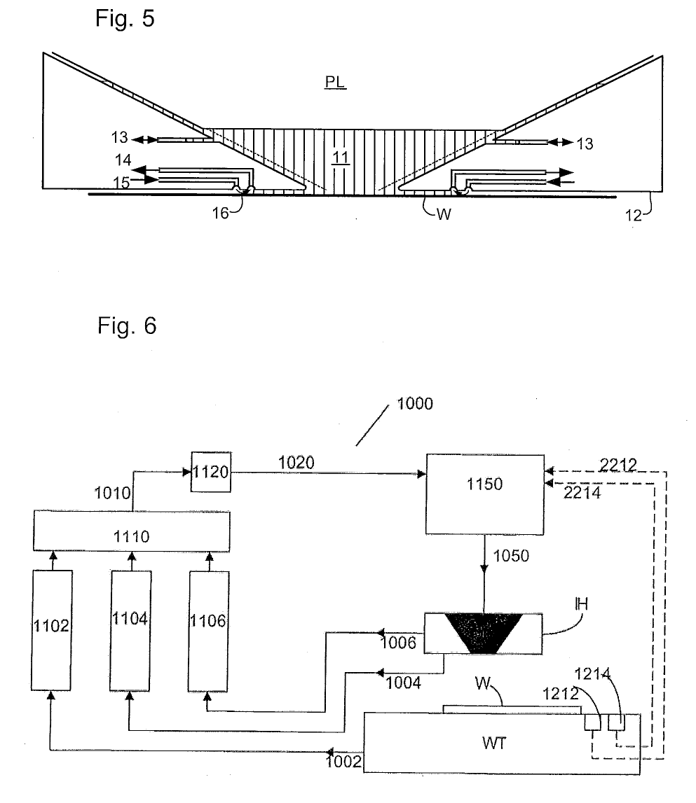

A further embodiment of an immersion lithography apparatus (e.g., a localized liquid supply system solution) has a liquid supply system that includes a seal member (or immersion hood), which extends along at least a part of a boundary of the space between the final element of the projection system and the substrate table. Such an embodiment is depicted in FIG. 5. The seal member may be substantially stationary relative to the projection system in the X-Y plane, though there may be some relative movement in the Z direction (i.e., in the direction of the optical axis). A seal is formed between the seal member and the surface of the substrate. Desirably, the seal is a contactless seal, such as a gas seal.

Referring to FIG. 5, a seal member 12 forms a contactless seal with the substrate around the image field of the projection system PL so that liquid is confined to fill a reservoir or an immersion space 11 between the substrate surface and the final element of the projection system PL. The reservoir 11 is formed by a seal member 12 positioned below and surrounding the final element of the projection system PL. Liquid is brought into the space 11 below the projection system PL and within the seal member 12 using, for example, inlet 13. The seal member 12 extends a little above the final element of the projection system PL and the liquid rises above the final element so that a buffer of liquid is provided. In an embodiment, the seal member 12 has an inner periphery that, at the upper end, closely conforms to the shape of the projection system PL or the final element thereof and may, for example, be round. At the bottom, the inner periphery closely conforms to the shape of the image field, for example, rectangular, though this need not be the case.

The liquid is confined in the reservoir 11 by a gas seal 16 between the bottom of the seal member 12 and the surface of the substrate W. In one embodiment, the gas seal 16 is formed by a gas, such as air or synthetic air. In an additional embodiment, nitrogen (N₂) or another inert gas may be provided. The seal is formed by providing gas under pressure via inlet 15 to the gap between seal member 12 and the substrate and extracted via outlet 14. The overpressure on the gas inlet 15, vacuum level on the outlet 14, and geometry of the gap are arranged so that there is a high-velocity gas flow inwards that confines the liquid. An exemplary system is disclosed in U.S. Pat. No. 6,952,253.

Other solutions are possible, and one or more embodiments of the present invention are equally applicable to those. For example, in place of the gas seal 16, it may be possible to have a single phase extractor which only extracts liquid. Radially outwardly of such a single phase extractor could be one or more features to produce a gas flow to help contain the liquid in the space. One embodiment of such a feature is a gas knife in which a thin jet of gas is directed downwards onto the substrate W. During scanning motion of the substrate under the projection system and the liquid supply system, hydrostatic and hydrodynamic forces may be generated which result in pressures on the liquid downwards towards the substrate.

With a localized area liquid supply system, the substrate W is moved under the projection system PL and the liquid supply system. The relative movement of the table may be to enable an edge of the substrate W or a sensor on the substrate table, to be imaged for sensing purposes or for substrate swap. Substrate swap is removal and replacement of the substrate W from the substrate table WT between exposures of different substrates. During substrate swap, for example, it may be desirable for liquid to be kept within the liquid confinement system 12. This is achieved by moving the liquid confinement system 12 relative to the substrate table WT, or vice versa, so that the liquid confinement system is placed over a surface of the substrate table WT away from the substrate W. In one embodiment, such a surface is a shutter member. Immersion liquid may be retained in the liquid confinement system by operating the gas seal 16 or by clamping the surface of the shutter member to the undersurface of the liquid confinement system 12. The clamping may be achieved by controlling the flow and/or pressure of fluid provided to the undersurface of the liquid confinement system 12. For example, the pressure of gas supplied from the inlet 15 and/or the under pressure exerted from the outlet 14 may be controlled.

The surface of the substrate table over which the liquid confinement system is placed may be an integral part of the substrate table, or in additional embodiments, the surface may be a detachable and or replaceable component of the substrate table. Such a detachable component may be referred to as closing disc or a dummy substrate. The detachable or separable component may be a separate stage. In a dual or multi stage arrangement, the entire substrate table is replaced during substrate exchange. In such an arrangement, the detachable component may be transferred between substrate tables. The shutter member may be an intermediate table that may be moved adjacent to the substrate table prior to substrate exchange. The liquid confinement system may then be moved onto the intermediate table, or vice versa, during, for example, substrate exchange. The shutter member may be a moveable component of the substrate table, such as a retractable bridge, which may be positioned between the stages during, for example, substrate exchange. The surface of the shutter member may be moved under the liquid confinement structure, or vice versa, during, for example, substrate exchange.

During substrate swap, an edge of the substrate W will pass under the space 11 and liquid may leak into the gap between the substrate W and substrate table WT. This liquid may be forced in under hydrostatic or hydrodynamic pressure or, alternatively or additionally, under the force of a gas knife or other gas flow creating device. A drain may be provided around the edge of a substrate W, for example, in the gap. In additional embodiments, the drain may be located around another object on the substrate table. Such an object may include, but is not limited to, one or more sensors and/or a shutter member used to maintain liquid in the liquid supply system by being attached to the bottom of the liquid supply system during, for example, substrate swap. Thus, any reference to the substrate W should be considered to be synonymous with any such other object, including a sensor or a shutter member, such as a closing plate.

For other exemplary lithographic systems, see generally U.S. Pat. No. 4,509,852, PCT patent application publication no. WO 99/49504, and European patent application publication no. EP 1,420,298.

Exemplary embodiments of the present invention have been and will be described in relation to a lithographic apparatus having an immersion system with a liquid handling system and drain, as described in the aforementioned figures. However, it will be apparent that the embodiments can be applied to any sort of immersion apparatus. In particular, they are applicable to any immersion lithographic apparatus in which defectivity, e.g., defect count density, is a problem that is reduced optimally and desirably minimized. The systems and components described in the earlier passages of the description are therefore exemplary systems and components. These embodiments may apply to other features of the immersion system that include, but are not limited to, cleaning systems and cleaning tools for in-line and off-line implementations; the immersion liquid supply and immersion liquid retrieval systems such as an ultra pure water supply system; and the gas supply and removal systems (e.g., a vacuum pump). The embodiments described below in relation to an immersion lithographic apparatus are optimized for supplying an immersion liquid. However, the embodiments are equally applicable for use with an immersion system that uses a fluid supply system supplying a fluid other than a liquid as the immersion medium.

FIG. 6 depicts a recycling system for use in or with a lithographic projection apparatus. In FIG. 6, the liquid supply system IH is illustrated schematically, as is the substrate table WT on which the substrate W may be supported. The solid arrows show the various flow paths of immersion liquid in the recycling system 1000. As can be seen, liquid is prepared in a liquid preparation module 1150. The liquid is supplied through line 1050 to the liquid supply system IH. The liquid supply system IH fills the space between the projection system PS and the substrate W and/or the substrate table WT with the liquid.

In the embodiment of FIG. 6, three types of immersion liquid are shown being removed from that space, although there may be less or more than three. The three types of liquid include: liquid 1002 that is extracted from the space through the substrate table WT; liquid 1004 that is extracted from the space through, for example, a gas knife extractor; and liquid 1006 that is extracted through, for example, an outlet in the side of the barrier member 12. Each of these types of liquids have their own respective liquid treatment units 1102, 1104, 1106 in the recycling system, as each liquid type may have different characteristic types of contaminants. The parallel liquid treatment units 1102, 1104, 1106 are respectively optimized to treat the respective flow of immersion liquid for the types of contaminants likely to be present in the liquids.

Thus, the parallel liquid treatment unit 1102, which treats the immersion liquid from the substrate table WT, has a degassing unit and a purifier. The degassing unit degases the immersion liquid which passes through it. The purifier purifies the immersion liquid. The purifier will be optimized to purify immersion liquid which has come into contact with the substrate table WT. The parallel liquid treatment unit 1102 includes one or more particle filters that are optimized to extract particles likely to have contaminated the immersion liquid in the substrate table WT. In the parallel liquid treatment units, the pores of the particle filter(s) are sized to remove fairly coarse particles.

The parallel liquid treatment unit 1104 for the liquid 1004, which exits through, for example, the gas knife extractor of the liquid supply system, has a degassing unit, a purifier and one or more particle filters. The purifier and one or more particle filters of the parallel liquid treatment unit 1104 are optimized for immersion liquid which has been in contact with the liquid supply system IH (e.g., barrier member 12). The unit 1104 will be optimized to remove particles and purify immersion liquid which has been acted on by, for example, a gas knife, which may result in its own particular type of impurities and particles.

As will be appreciated, the liquid 1002 may have been in contact with the liquid supply system IH, and the liquid 1004 may have been in contact with the top surface of the substrate table WT.

The liquid 1006 has simply passed across the space below the projection system and within member 12, and therefore, liquid 1006 is likely to be removed from the space as a single phase. In the embodiment of FIG. 6, liquid 1006 is treated by the liquid treatment unit 1106 and may not pass through a degassing unit. This is because there will likely be no gas in the liquid because there would have been no or little opportunity for gas to be introduced. However, the liquid treatment unit 1106 may comprise a purifier and one or more particle filters optimized to remove particles that are likely to exist in the liquid supply system.

The three flows described above are for illustrative purposes only. In additional embodiments, other flows may be accommodated without departing from the spirit or scope of the present invention. For example, the embodiment of FIG. 6 may include a single phase flow extracted through an extractor between the liquid supply system IH and the substrate W.

The flows of liquid out of the parallel liquid treatment units 1102, 1104, 1106 are combined by a fluid cycling integrator 1110. The liquid is supplied further as flow 1010 to a container or buffer 1120. There, the liquid is stored until it is used by the fluid preparation unit 1150. The fluid preparation unit 1150 may itself comprise several units to treat the liquid prior to supplying the liquid to the liquid supply system IH. The fluid preparation unit 1150 can be seen as a serial liquid treatment unit. All of the recycled immersion liquid will pass through the fluid preparation unit 1150 from the container 1120 via flow 1020. The fluid preparation unit 1150 could contain one or more of a degassing unit, a temperature control unit, a flow control unit, and a refractive index control unit. In the embodiment of FIG. 6, the fluid preparation unit 1150 has a fine particle filter unit for final filtration after the one or more coarse filters of the parallel liquid treatment units 1102, 1104, and 1106. In additional embodiments, any portion of the fluid preparation unit 1150 could be positioned separately in the flow paths 1010 or 1020.

Elements of the fluid preparation unit 1150 may be controlled in a feed-back manner based on measurements taken at the substrate table WT using one or both of sensors 1212 and 1214. Sensor 1212 could, for example, be a wavefront sensor. Additionally or alternatively, sensor 1214 could be an intensity (absorption) sensor. Based on the measurement results of one or both of these sensors, the fluid preparation unit 1150 and the rest of the lithographic apparatus could be controlled using control signals 2212 and 2214 to achieve the correct wavefront position and dose. Additionally, the fluid preparation unit 1150 could vary how the immersion fluid is prepared prior to entering the liquid supplied system IH. Thus, the fluid preparation unit 1150 controls the refractive index (e.g., by temperature variation). One or both of the sensors described above could also be used in determining when it is necessary to renew the immersion liquid in the circuit 1000. In one embodiment, it is desirable to ensure that the absorption remains below a predetermined maximum acceptable level and that the refractive index remains stable, and if not, that the refractive index is known so that the necessary optical corrections can be made. Alternatively or additionally, there could be a regular program in place for a periodical replacement of liquid in the circuit 1000.

In one embodiment, parts of the recycling system 1000 could be supplied within the main portion of the immersion lithographic apparatus. Other parts, in particular the parallel treatment units, could be provided as a separate unit from the bulk of the immersion lithographic apparatus.

The apparatus of this and other embodiments may be part of a closed system or a partially closed system. This is in contrast to an open system in which immersion liquid that is removed from the lithographic apparatus is either disposed or re-worked offline and later re-supplied to the lithographic apparatus. In a closed system, the liquid in the apparatus is continually recycled and the liquid is not replenished in use with fresh liquid. In closed and partially closed systems, it may be necessary to include two paths through which the fluid may be recycled to compensate for a potential failure of a part of the recycling system. Thus, effectively, there would be one or more valves to divert the liquid from, for example, one or more of the liquid treatment units 1102, 1104, and 1106, fluid cycling integrator 1110, container 1120, and fluid preparation unit 1150 to a separate circuit comprising the same components. The valve(s) may be part of one or more of those devices or in the flow path before or after one or more of those devices as appropriate. In a partially closed system, fresh liquid can be added (e.g., to the container 1120 during operation of the recycling system). Liquid exiting the liquid supply system IH or substrate table WT could be diverted to be disposed of or to be re-worked offline prior to being re-supplied to the container 1120. Using such a system, new immersion liquid can be added into the circuit 1000 without interruption of the flow of immersion liquid, thus eliminating or substantially reducing downtime of the whole apparatus.

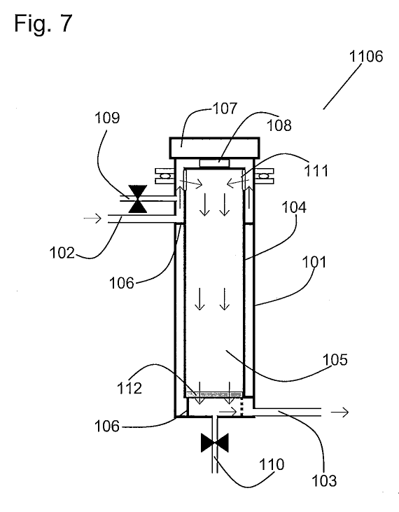

FIG. 7 depicts an embodiment of liquid treatment unit 1106. The liquid treatment unit 1106 comprises a housing 101 having an inlet 102 to receive the liquid, a first outlet 103 to let out treated liquid, and a cartridge 104 comprising a fiber 105. Cartridge 104 comprises filter barriers 111 and 112 that collectively allow a flow of liquid through the cartridge while retaining the fiber 105 inside the cartridge. Housing 101 supports cartridge 104 by supporting flanges 106. A top 107 having a pressure pad 108 clamps cartridge 104 in the housing 101. Housing 101 further comprises a second inlet 109 to introduce a gas or second liquid into the housing and a second outlet 110 to drain liquid and gas out of the housing.

In one embodiment, the inlet 102 may include a valve to receive the liquid, the first outlet 103 may include a valve to let out treated liquid, and the second inlet 109 may include a valve to introduce the gas or the second liquid into the housing. The gas or second liquid may include, but is not limited to, a fluid to clean a fiber, such as fiber 105. In an additional embodiment, the inlet 102 and second inlet 109 may be combined into a single further inlet, or the first and second outlets 109, 110 may be combined into a single further outlet, or both.

In the embodiment of FIG. 7, the liquid treatment unit receives liquid through inlet 102. The liquid enters the cartridge through filter barriers 111 and leaves the cartridge through filter barriers 112. Flanges 106 form a seal to prevent liquid from bypassing the cartridge. After passing through the cartridge and undergoing treatment in the cartridge, treated liquid is let out of the liquid treatment unit through outlet 103. The liquid received through inlet 102 may have been exposed to the radiation beam and may therefore contain organic contaminant particles. On passing through the cartridge, the liquid comes into contact with the fiber, and the fiber absorbs the organic contaminant particles. The contaminant particles collect onto the surface of the fiber. An advantage of using a fiber may be that no particles are created in the interaction between the liquid and the fiber. Due to the fixed, stationary arrangement of the fiber in the cartridge, portions of fibers do not substantially rub together when forces of the liquid flow are applied to the fiber. Thus, forces between different fibers are minimized or reduced, preventing particle generation.

In one embodiment, the housing may be made of stainless steel. The cartridge may be made of Teflon. In additional embodiments, the fiber may be a spun fiber and may be substantially made of SiO₂, quartz, Al₂O₃, or any ratio of SiO₂ and Al₂O₃. In an embodiment, the ratio of SiO₂ and Al₂O₃ may be approximately 4:1. Alternatively, other fiber materials may be used that are compatible with the liquid (i.e., that will not be dissolved by or chemically interact with the liquid). The fiber material may be any natural or synthetic fiber material, including, but not limited to, cotton. The fiber may have a diameter in a range of 1.5 μm to 150 μm. The fiber may be arranged in the cartridge in a thread winding pattern, i.e. spun into coarser ropes or any random arrangement. Alternatively, the fiber may be spun onto a spool or into a matting arrangement, e.g., a crisscross-thread-winding pattern, and then wrapped onto a roll or another body having a predetermined shape.

In an embodiment, the surface of the fiber may be roughened in order to increase the surface area of the fiber which is in contact with the liquid. For example, the surface may be pitted. A roughened surface of the fiber may be obtained by chemical treatment of the fiber, such as etching or mechanical abrasion. A roughened surface is particularly advantageous in an embodiment having a fiber with a large diameter such as 150 μm. The increase in surface area due to the surface roughening compensates for the smaller surface area of a larger diameter fiber. A SiO₂ fiber having a treated surface may be referred to as activated SiO₂, whereas a SiO₂ fiber of which the surface has not been treated may be referred to as non-activated SiO₂.

In an embodiment, the cartridge may have a length of approximately 30 cm and a diameter of approximately 15 cm. Larger cartridges may be used or, alternatively or additionally, multiple cartridges may be used, such as where the cartridges are arranged in parallel or cascaded. The cartridge may include flow baffles, which may increase the path length of the flowing liquid through the fiber material. To achieve this effect, in one embodiment, the baffles are arranged on the inner side of the cartridge. The arrangement of flow baffles impedes a radial flow of the liquid and promotes a tangential flow of the liquid. Such baffles may be arranged in a winding pattern.

After a period of operation of the liquid treatment unit, the fiber 105 may become saturated with organic particles. At this time, either the cartridge 104 comprising the fiber 105 may be replaced by a different cartridge, or the cartridge 104 used at that time may be cleaned using a solvent. The replacement and/or cleaning may minimize the downtime of the lithographic apparatus.

The cartridge may be replaced by interrupting the flow of liquid entering the liquid treatment unit through inlet 102, draining any remaining liquid by opening the second outlet 110, removing top 107, and taking out the cartridge (during this operation, flow of immersion fluid through the immersion system may be stopped). Alternatively or additionally, while draining the liquid, a gas may be introduced into the housing through second inlet 109. The gas may be any inert gas, such as N₂, and dries the cartridge while draining the liquid such that the cartridge may be removed without contaminating other parts of the recycling system. In this embodiment, second outlet 110 is arranged to let out both the liquid and the gas.

Instead of, or in addition, to replacing cartridge 104 with a new cartridge comprising a fresh fiber, the fiber 105 of the used cartridge 104 may be cleaned. To clean the used cartridge 104, the fiber 105 may be backwashed with a solvent in which the contaminants dissolve. The solvent may be any fluid comprising acetone, isopropanol (IPA), ozone, hydrogen peroxide, or any other solvent that does not dissolve the fiber and the housing. Alternatively or additionally, the fiber of the used cartridge may be cleaned by irradiating the fiber with UV radiation while passing ambient air, O₂, ozone or a liquid such as H₂O₂, through the fiber material.

In an embodiment, it may not be necessary to remove the cartridge from the housing to clean the fiber. The liquid treatment unit may be arranged to introduce, for example, a solvent into the housing 101. The fiber and the housing may be cleaned in situ.

In one embodiment, the fiber may be cleaned by: (i) interrupting the flow of liquid entering the liquid treatment unit through inlet 102; (ii) draining any remaining liquid by opening the second outlet 110; and (iii) introducing a solvent material into the housing through second inlet 109. In this embodiment, second outlet 110 is arranged to let out both the liquid and the solvent. After cleaning, the fiber and inner side of the housing may be dried by introducing an inert gas. In a similar way, the cleaning by irradiating the fiber with UV radiation while passing ambient air, O₂, ozone or a liquid such as H₂O₂, through the fiber material may be accomplished.

The above described replacement of the cartridge or cleaning of the fiber may be performed periodically. The cleaning may occur after a predetermined amount of operation of the lithographic apparatus. Alternatively or additionally, the cleaning may occur after determining the amount of contaminant particles in the liquid or at any other event.

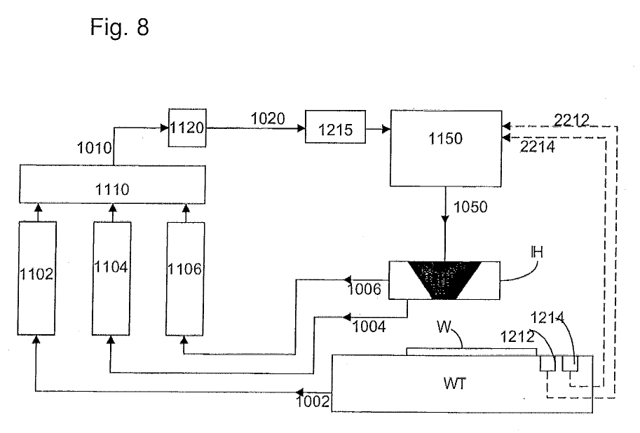

FIG. 8 shows an embodiment of the recycling system including a sensor 1215, which may be used to measure a physical property of the liquid indicative for the quality of the liquid. The sensor may be configured to directly measure the amount of organic contaminants in the liquid by, for example, performing a chemical analysis. Alternatively or additionally, the amount of organic contaminants may be determined by measuring an effect of the contaminants on a physical property of the liquid, such as an intensity or a change in an intensity of a radiation beam passing through the liquid, or a radiation absorption of the liquid, or the refractive index of the liquid, or a wavefront position error in a radiation beam passing through the liquid. Further, one or more of these measurements may be combined. The sensor may be arranged within the liquid treatment unit 1106, fluid cycling integrator 1110, buffer 1120, fluid preparation unit 1150, or as depicted in FIG. 8, in a line from one of these units to the subsequent unit. A control unit may be arranged to use the output of the sensor to adjust a parameter of the recycling system to achieve a desired property of the liquid or to adjust an imaging parameter of the lithographic apparatus, or both. In an embodiment, the control unit may trigger on detection of a predetermined value of a physical property of the liquid. Alternatively or additionally, the control unit may trigger on detection of an amount of measured contaminants in the liquid. The control unit may trigger to initiate a warning, which may prompt the replacement of the cartridge or the cleaning of the fiber. The control unit may, in addition or alternatively, trigger to start an automated replacement or cleaning process. The control unit may select which option to take depending on the measurement of contaminants, a measurement of a physical property of the liquid, any previous such measurements, detected changes in the measured contaminants, and/or detected changes in one or more physical properties of the immersion liquid.

In the above described embodiments of the liquid treatment unit 1106, the liquid treatment unit comprises separate inlets 102 and 109 and corresponding separate outlets 103 and 110. A skilled artisan would recognize that any other arrangement, wherein for example the inlets are combined in one inlet or the outlets are combined in one outlet, may be used. When combining two or more inlets or outlets, separate piping may be used that are combined for connecting with the housing using a single inlet.

In the above described embodiments of the liquid treatment unit, the fiber is in a cartridge. Desirably, the fiber is within the cartridge and the cartridge may hold the fiber. In a further embodiment, the fiber may not be held in a cartridge, but directly fitted into housing 101. Such an embodiment may be used where replacement of the fiber is not necessary due to the described integrated cleaning step, or alternatively, where the spun fiber material is such that handling without a cartridge is possible.

In the above described embodiments of the recycling system, the liquid treatment unit 1106 comprises a fiber to absorb organic contaminants. However, any of the liquid treatments units 1102 and 1104, fluid cycling integrator 1110, container 1120, or fluid preparation unit 1150 may comprise such a fiber to absorb organic contaminants.

In an embodiment, the fiber may be fed through the immersion liquid flow constantly such that fresh fiber is introduced in the immersion liquid flow at a predetermined rate. Equally, fiber material having contaminant particles adhered to the surface of the fiber due to the fiber being exposed to the immersion liquid may be removed from the immersion liquid flow at a predetermined rate. Fiber material having contaminant particles adhered to the surface may be fed through a cleaning station to clean the fiber. Subsequently, the fiber may be reintroduced into the immersion liquid flow.

In an aspect, there is provided a lithographic apparatus for immersion lithography comprising a projection system configured to project a patterned radiation beam onto a target portion of a substrate, wherein a substrate table is configured to support the substrate, a liquid supply system configured to provide a liquid to a space between the projection system and the substrate or the substrate table, and a recycling system configured to collect liquid from the liquid supply system and to supply the liquid to the liquid supply system, wherein the recycling system comprises a fiber to filter organic particles. Optionally, the fiber comprises a spun fiber. Optionally, the fiber comprises substantially SiO₂. Optionally, the fiber comprises substantially Al₂O₃. Optionally, the fiber comprises SiO₂ and Al₂O₃ in a ratio substantially of 4:1. Optionally, the fiber comprises a roughened surface to increase a contact surface with the liquid. Desirably, the fiber is chemically treated to obtain the roughened surface. Optionally, the fiber is arranged in a crisscross thread winding pattern. Optionally, the recycling system further comprises a cartridge configured to hold the fiber and arranged to be removable from the recycling system. Desirably, the recycling system further comprises a housing configured to hold the cartridge, wherein the housing comprises a first inlet having a valve to receive liquid, a first outlet having a valve to let filtered liquid out of the housing, a second outlet to drain the liquid, and a second inlet having a valve to receive a second fluid to clean the fiber. Desirably, the first and second inlets are combined into a single further inlet, or the first and second outlets are combined into a single further outlet, or both. Desirably, the second fluid comprises at least one selected from the group: acetone, isopropanol, ozone, or nitrogen. Optionally, the lithographic apparatus further comprises a sensor configured to measure a physical property of the liquid indicative of its quality. Desirably, the sensor is configured to measure (i) an intensity of a radiation beam passing through the liquid, or (ii) a radiation absorption of the liquid, or (iii) a refractive index of the liquid, or (iv) a wavefront position error in a radiation beam passing through the liquid, or (v) any combination of (i)-(iv). Desirably, (i) an output of the sensor is used to adjust a parameter of the recycling system to achieve a desired property of the liquid, or (ii) an output of the sensor is used to adjust an imaging parameter of the lithographic apparatus, or (iii) both (i) and (ii).

In an aspect, there is provided a device manufacturing method comprising projecting a patterned beam of radiation onto a substrate through a liquid provided in a space between a projection system and a substrate, removing liquid from the space and filtering the liquid using a particle filter comprising a fiber, and providing at least some of the filtered liquid to the space. Optionally, the method further comprises measuring a physical property of the liquid indicative of its quality. Desirably, the method further comprises adjusting the filtering of the liquid based on the measurement of the physical property of the liquid.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g., having a wavelength of or about 365, 248, 193, 157 or 126 nm) or extreme ultraviolet radiation.

The term “lens,” where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g., semiconductor memory, magnetic or optical disk) having such a computer program stored therein. Further, the machine readable instruction may be embodied in two or more computer programs. The two or more computer programs may be stored on one or more different memories and/or data storage media.

The controllers described above may have any suitable configuration for receiving, processing, and sending signals. For example, each controller may include one or more processors for executing the computer programs that include machine-readable instructions for the methods described above. The controllers may also include data storage medium for storing such computer programs, and/or hardware to receive such medium.

The embodiments can be applied to any immersion lithography apparatus, and exemplary apparatus include, but are not limited to, those types mentioned above.

One or more embodiments of the invention may be applied to any immersion lithography apparatus in which the immersion liquid is provided in the form of a bath, is confined to a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. Such a liquid supply system may include a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The immersion liquid used in the apparatus may have different compositions, according to the desired properties and the wavelength of exposure radiation used. For an exposure wavelength of 193 nm, ultra pure water or water-based compositions may be used and for this reason the immersion liquid is sometimes referred to as water and water-related terms such as hydrophilic, hydrophobic, humidity, etc. may be used, although they should be considered more generically. It is intended that such terms should also extend to other high refractive index liquids which may be used, such as a fluorine containing hydrocarbon.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A lithographic apparatus for immersion lithography, comprising:
a projection system configured to project a patterned radiation beam onto a target portion of a substrate, wherein a substrate table is configured to support the substrate;
a liquid supply system configured to provide a liquid to a space between the projection system and the substrate or the substrate table; and
a recycling system configured to collect liquid from the liquid supply system and to supply the liquid to the liquid supply system, the recycling system comprising a fiber to filter organic particles.

2. The lithographic apparatus of claim 1, wherein the fiber comprises a spun fiber.

3. The lithographic apparatus of claim 1, wherein the fiber comprises substantially SiO₂.

4. The lithographic apparatus of claim 1, wherein the fiber comprises substantially Al₂O₃.

5. The lithographic apparatus of claim 1, wherein the fiber comprises SiO₂ and Al₂O₃ in a ratio substantially of 4:1.

6. The lithographic apparatus of claim 1, wherein the fiber comprises a roughened surface to increase a contact surface with the liquid.

7. The lithographic apparatus of claim 6, wherein the fiber is chemically treated to obtain the roughened surface.

8. The lithographic apparatus of claim 1, wherein the fiber is arranged in a crisscross thread winding pattern.

9. The lithographic apparatus of claim 1, wherein the recycling system further comprises a cartridge configured to hold the fiber and arranged to be removable from the recycling system.

10. The lithographic apparatus of claim 9, wherein the recycling system further comprises:
a housing configured to hold the cartridge, wherein the housing comprises a first inlet having a valve to receive liquid, a first outlet having a valve to let filtered liquid out of the housing, a second outlet to drain the liquid, and a second inlet having a valve to receive a second fluid to clean the fiber.

11. The lithographic apparatus of claim 10, wherein (i) the first and second inlets are combined into a single further inlet, or (ii) the first and second outlets are combined into a single further outlet, or (iii) both (i) and (ii).

12. The lithographic apparatus of claim 10, wherein the second fluid comprises at least one selected from the following: acetone, isopropanol, ozone, or nitrogen.

13. The lithographic apparatus of claim 1, further comprising a sensor configured to measure a physical property of the liquid indicative of its quality.

14. The lithographic apparatus of claim 13, wherein the sensor is configured to measure (i) an intensity of a radiation beam passing through the liquid, or (ii) a radiation absorption of the liquid, or (iii) a refractive index of the liquid, or (iv) a wavefront position error in a radiation beam passing through the liquid, or (v) any combination of (i)-(iv).

15. The lithographic apparatus of claim 13, wherein (i) an output of the sensor is used to adjust a parameter of the recycling system to achieve a desired property of the liquid, or (ii) an output of the sensor is used to adjust an imaging parameter of the lithographic apparatus, or (iii) both (i) and (ii).

16. A device manufacturing method comprising:
projecting a patterned beam of radiation onto a substrate through a liquid provided in a space between a projection system and a substrate;
removing liquid from the space and filtering the liquid using a particle filter comprising a fiber; and
providing at least some of the filtered liquid to the space.

17. The method of claim 16, further comprising measuring a physical property of the liquid indicative of its quality.

18. The method of claim 17, further comprising adjusting the filtering of the liquid based on the measurement of the physical property of the liquid.
